(19) United States
(12) Patent Application Publication
(10) Pub. No.: US 2025/0077695 A1
(43) Pub. Date: Mar. 6, 2025

(54) SYSTEMS, METHODS, AND COMPUTER-READABLE MEDIA FOR PRIVACY FEATURES WITHIN A CHAT ENVIRONMENT

(71) Applicant: FYI.FYI, INC., Los Angeles, CA (US)

(72) Inventor: William Adams, LOS ANGELES, CA (US)

(21) Appl. No.: 18/821,112

(22) Filed: Aug. 30, 2024

Related U.S. Application Data
(60) Provisional application No. 63/535,987, filed on Aug. 31, 2023.

(51) Int. Cl. G06F 21/62

(52) U.S. Cl. CPC G06F 21/6218

(57) ABSTRACT

A computing apparatus for protecting privacy within a messaging platform includes one or more processors and one or more computer-readable media having stored thereon executable instructions. The executable instructions, when executed by the one or more processors, cause the computing apparatus to receive a user's attempt to access content shared within the messaging platform, determine whether or not privacy is set for protection within the messaging platform, and in a case where it is determined that the privacy is set for protection, disallow an access to the content and display a notification of protection of the content to a user. In a case where it is determined that the privacy is not set for protection, the computing apparatus is further caused to allow the user to access the content.

### CROSS-REFERENCE TO RELATED APPLICATIONS

This application claims the benefit of and priority to U.S. Provisional Patent Application Ser. No. 63/535,987 filed on Aug. 31, 2023, and entitled “PRIVACY FEATURES WITHIN A CHAT ENVIRONMENT,” which is expressly incorporated herein by reference in its entirety.

### FIELD

The present disclosure relates generally to systems, methods, and computer-readable media for privacy, and particularly for protecting privacy within a chat environment.

### BACKGROUND

Computers and computing systems have affected nearly every aspect of modern living. Computers are generally involved in work, recreation, healthcare, transportation, entertainment, household management, etc. In recent decades, computers have provided significant advances and paradigm shifts in communication. In contrast to sending a physical letter or even a fax, individuals are now able to communicate with another individual or a group instantly using text communication, audio communication, or video communication.

Digital communication has reshaped both personal relationships and professional relationships. Where previously, workers may have needed to be in the same room to collaborate and work together, now entire teams seamlessly collaborate remotely through messaging platforms. Modern messaging platforms allow users to communicate, share documents, store documents, keep notes, and perform various other common day-to-day work activities.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The present disclosure is related to systems, methods, and computer readable media for protecting privacy within a chat environment. These systems, methods, and computer readable media particularly provide privacy settings to protect texts, documents, multimedia files, and any other content shared within the messaging platform. Further, these systems may intercept system-level shortcuts to prevent unauthorized screen-capturing, screen-recording, sharing, forwarding, or copying of the contents within the messaging platform.

The privacy features are implemented through novel and innovative technical means to protect the privacy of chat participants and shared materials within one-to-one chats and within group chats. According to one aspect of the present disclosure, a computing apparatus for protecting privacy within a messaging platform includes one or more processors and one or more computer-readable media having stored thereon executable instructions. The executable instructions, when executed by the one or more processors, cause the computing apparatus to receive a user's attempt to access content shared within the messaging platform, determine whether or not privacy is set for protection within the messaging platform, and in a case where it is determined that the privacy is set for protection, disallow an access to the content; and display a notification of protection of the content to a user. In a case where it is determined that the privacy is not set for protection, the computing apparatus is further caused to allow the user to access the content.

According to another aspect, a method for protecting privacy within a messaging platform includes receiving a user's attempt to access content shared within the messaging platform, determining whether or not privacy is set for protection within the messaging platform, and in a case where it is determined that the privacy is set for protection, disallowing an access to the content, and displaying a notification of protection of the content to a user. The method further includes, in a case where it is determined that the privacy is not set for protection, allowing the user to access the content.

According to still other aspect, a nontransitory computing readable content having stored thereon executable instructions that, when executed by a computing apparatus, cause the computing apparatus to perform a method for protecting privacy within a messaging platform. The method receiving a user's attempt to access content shared within the messaging platform, determining whether or not privacy is set for protection within the messaging platform, and in a case where it is determined that the privacy is set for protection, disallowing an access to the content, and displaying a notification of protection of the content to a user. The method further includes, in a case where it is determined that the privacy is not set for protection, allowing the user to access the content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific aspects which are illustrated in the appended drawings. Understanding that these drawings depict only typical aspects and are not therefore to be considered to be limiting in scope, aspects will be described and explained with additional specificity and detail through the use of the accompanying drawings in which:

FIG. 1 illustrates a messaging system in accordance with various aspects of the present disclosure;

FIGS. 2A-2D illustrate graphical illustrations of a messaging application for privacy protection settings in accordance with various aspects of the present disclosure;

FIGS. 3A-3C illustrate graphical illustrations of a messaging application for privacy protection settings for a one-to-one chat in accordance with various aspects of the present disclosure;

FIGS. 4A-4C illustrate graphical illustrations of a messaging application for privacy protection settings for a group chat in accordance with various aspects of the present disclosure;

FIGS. 5A-5C illustrate graphical illustrations of a messaging application for privacy protection settings against screen-capturing or screen-recording in accordance with various aspects of the present disclosure;

FIGS. 6A and 6B illustrate graphical illustrations of a messaging application for privacy protection settings for a project chat in accordance with various aspects of the present disclosure;

FIG. 7 illustrates a flow chart of a method for privacy protection settings in accordance with various aspects of the present disclosure; and

FIG. 8 illustrates a block diagram of a computing device in accordance with various aspects of the present disclosure.

### DETAILED DESCRIPTION

The present disclosure is related to systems, methods, and computer readable media for protecting privacy within a chat environment. Various aspects of the present disclosure include various security and privacy settings that protect data shared during audio calls, video calls, and/or chats. The settings may be adjustable based upon the number of participants or users participating in the chat or call. Further, the settings may protect particular projects or sets of data from extraction or sharing.

As used herein, a “chat” comprises an audio call, a video call, a one-to-one digital communication, a group digital communication, a text chat, or any other form of digital communication. Such features may allow for the more open sharing of information and thoughts. Additionally, privacy and security settings may provide for greater security within an increasingly connected world where trade secrets, copyrighted content, and other intellectual property can easily be leaked or stolen by bad actors.

As used herein, the term “or” may be used in the following manner. For example, “A or B” comprises “A” itself, “B” itself, or combination of “A” and “B.” Likewise, “A, B, or C” may comprises “A” itself, “B” itself, “C” itself, combination of “A” and “B,” combination of “A” and “C,” combination of “B” and “C,” and combination of “A,” “B,” and “C.” This applies to any number of items connected with “or.”

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Further, the methods may be practiced by a computer system including one or more processors and computer-readable media such as computer memory. In particular, the computer memory may store computer-executable instructions that, when executed by the one or more processors, cause various functions to be performed, such as the acts recited in the aspects.

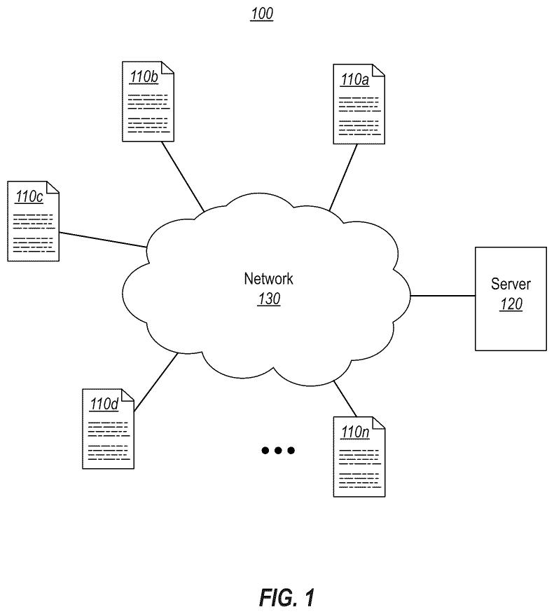

Referring now to FIG. 1, illustrated is a messaging system 100, which includes a plurality of computing devices 110a-110n of users. The messaging system 100 may further include a messaging server 120 and a communication network 130, in which the computing devices 110a-110n may communicate with each other via the messaging server 120. Hereinafter, an individual computing device may be referred to as a computing device 110 and a plurality of computing devices may be referred to the computing devices 110 collectively.

The messaging server 120 may provide server functionalities for messaging among the computing devices 110. In this regard, each computing device 110 may have to install a messaging application thereon and each user of the computing device 110 may have to register at the messaging server 120 through the messaging application. The user may have to provide authentication information, such as login identification (ID) and password, and the messaging server may store the authentication information in a memory. When the user runs the messaging application and enters the login ID and password, the messaging application relays the login ID and password to the messaging server 120, and when the messaging server 120 authenticates the user based on the login ID and password, the user may be able to use the messaging application.

In aspects, the messaging server 120 may be a cloud server functioning as a Software as a Service (SAAS) or a Platform as a Service (“PaaS”).

The users of the computing devices 110 may, based on the service provided by the messaging server 120, participate in a one-to-one or group chatting room or make a voice or video call to each other in the one-to-one chat or in the group chatting room. Further, users may be able to initiate a project with other users in a project chatting room.

When a user of the computing device 110 initiates a one-to-one chatting room and invites another user, both users may be able to communicate with each other via the chatting room through the communication network 130. In one or more aspects, the communication network 130 may be a wired or wireless network and follow Bluetooth protocol, hypertext transfer protocol (HTTP), simple network management protocol (SNMP), or any other suitable network protocols.

In a one-to-one chatting room or a group chatting room, users may be able to communicate with each other through text messages, emoticons, images, audio messages, or video messages. Even assuming that each user shares their own messages without worrying about copyright infringement or privacy invasion, it is possible that other users might be able to copy, share, or forward such messages to others. Further, even if they do not directly copy and share those messages, they might be able to screen-capture the content displayed on the screen of the computing device 110 or to screen-record the moving images played on the screen or audios played by the speaker, thereby enabling users to indirectly share the content with other users in the form of the screen-captured images and the screen-recorded videos. That might result in potential privacy invasion or copyright infringement. To prevent such potential privacy invasion and copyright infringement, the messaging application may be provided with security and privacy settings, which will be further described below.

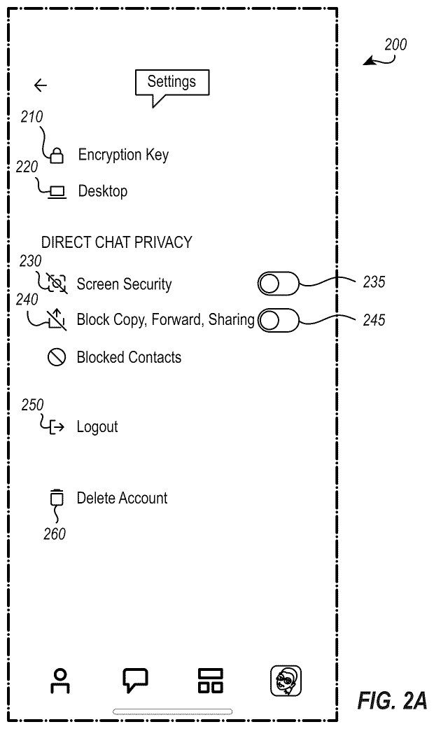

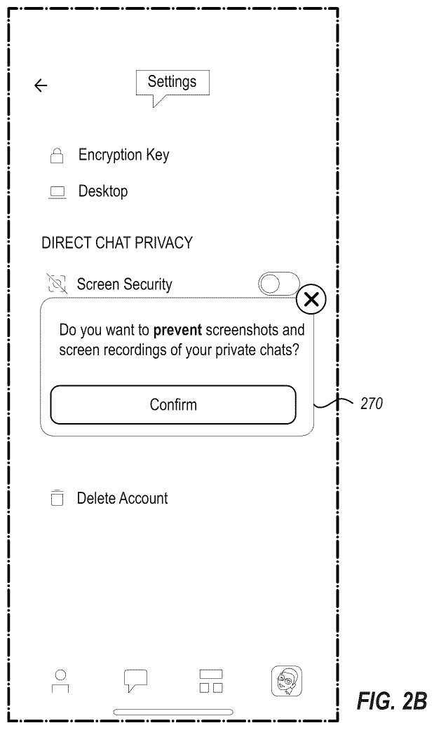

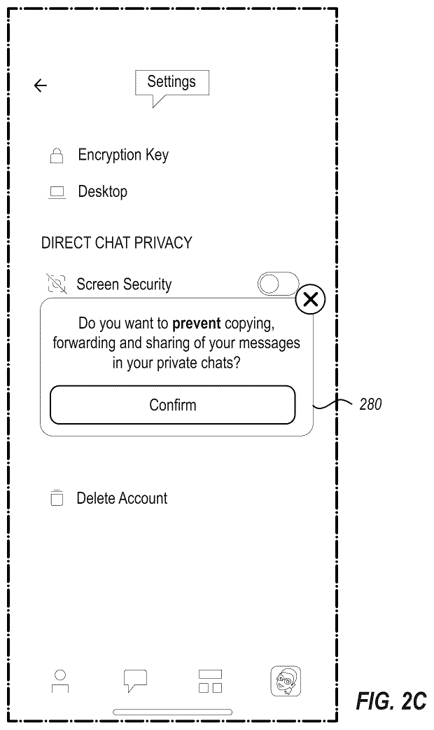

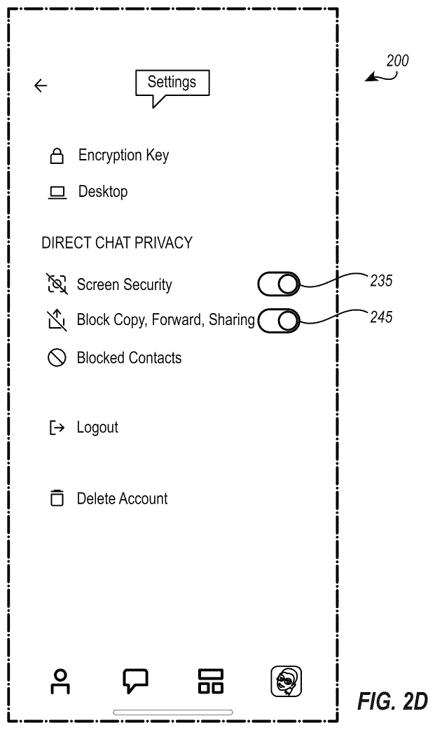

Now turning to FIG. 2A, Illustrated is a graphical illustration of a user application setting screen 200 of the messaging application installed in the computing device 110. The user application setting screen 200 may enhance user privacy and security for chat functionalities. The user application setting screen 200 may comprise two groups of menu items. The first group may be applicable to the messaging application, and the second group may be applicable to any chatting rooms initiated by the user of the computing device 110.

The first group may include an encryption key item 210, a desktop item 220, a logout item 250, and a delete account item 260. The encryption key item 210 is for managing or viewing encryption keys associated with the user's login information including a login ID and a password. For example, the encryption key item 210 may be the login ID and the password. Additionally or alternatively, the encryption key item 210 may be a key to encrypt the login ID and the password or to encrypt content of chats to protect any third party from accessing the content, thereby ensuring and increasing user's privacy and security.

The desktop item 220 may be used to set settings, such as a display mode (e.g., normal or dark mode), for the desktop of the application.

The logout item 250 may be used to log out from the messaging application, and the delete account item 260 may be used to delete the user's account from the messaging application. In a case where the logout item 250 is selected, the user is able to log out from the messaging application. The user may be able to rejoin chatting rooms without losing any messages even when the user logs out. In another aspect, when the user logs out from the messaging application, the user may leave every chatting room and lose all messages and content shared in the chatting rooms. To use the messaging application after logging out, the user needs to enter authentication information including the login ID and password.

In a case where the delete account item 260 is selected, the user's account is removed from the messaging server 120 so that the user is no longer able to use the messaging application unless otherwise re-registered at the messaging server 120 via the messaging application.

The second group may include a screen security item 230 and a screen block item 240. The screen security item 230 may be related to blocking screen-capture and screen-recording. Even though the current setting for the screen security item 230 is OFF as a radio button is positioned in the left side of a radio button switch 235, the default setting may be ON for the screen security item 230. When the screen security item 230 is set to be ON, the user is prohibited from screen-capturing or screen-recording content displayed on the screen of the computing device 110, and further, any other users invited to or participating in the chatting room initiated by the user may also be prohibited from screen-capturing or screen-recording.

Generally, the function of screen-capturing may be performed by the operating system or the system via a system-level hotkey. For example, according to one version of Android systems of smart devices, when the volume down button and the power button are simultaneously pressed and released, the function of screen-capture is performed to capture an image of the content displayed on the screen of the smart device (e.g., a smartphone, a tablet, etc.).

Likewise, screen-recording may be performed by a system-level menu or hotkey according to one version of Android systems of smart devices. For example, to initiate a screen recording, the user needs to swipe down from the top of the smart device screen to access Quick Settings Panel and swipe right to find and select the screen record icon.

In iOS systems, when the smart device has a Touch ID functionality, the side button and the home button need to be simultaneously pressed and released to screen-capture an image of the content displayed on the screen, and when the smart device has a Face ID functionality, the side button and the volume up button have to be simultaneously pressed and released to screen-capture an image displayed on the screen. To start a screen recording, the user needs to go to Settings and to Control Center, and to find and select Screen Recording. That adds a screen recording icon to Control Center. Then, the use has to open Control Center and select the screen recording icon to initiate the screen recording. These steps for initiating the functions of screen-capturing and screen-recording are provided as examples and are not meant to be limited thereto. Other ways or steps may be also applied to initiate such functions based on types or versions of operating systems of the computing devices.

These steps to initiate the screen-capturing and screen-recording may be applicable to some operating systems, which has been released after a specific version and may not be applicable to any operating systems before the specific version. Regardless, the screen-capturing and screen-recording may be performed at the system-level or by the application-level. Thus, when the screen-capturing and screen-recording are system-level functions, messaging applications may not be able to directly intercept the hotkeys for the screen-capturing or screen-recording before the system performs the screen-capturing or screen-recording function. In this situation, the system may designate a predetermined folder so that screen-captured images or screen-recorded videos are saved at the predetermined folder.

In aspects, the images captured by the screen-capture function may have an extension (e.g., “jpeg,” “jpg,” “png,” “tiff,” “gif,” or any other image file format) in their file names. Since the function of screen-capture might capture content (e.g., images), which may be confidential or copyrighted. In this case the image captured by the function of screen-capture might infringe the copyright of the owner. Further, some content shared at a chatting room might be private or offensive to someone. Hence, by capturing the image of the content displayed on the screen, privacy of someone might be invaded. Thus, by setting the screen security item 230 to be ON, such potential privacy invasion and copyright infringement can be avoided.

The audio and video files captured by the function of screen-recording may have an extension (e.g., “mp4,” “mp3,” “aac,” “ogg,” “wav,” “pcm,” “webm,” “wmv,” “avi,” “mkv,” or any other multimedia file format) in their file names. Since the video files record not only content displayed on the screen but also movies, audio, and visuals played by the computing device 110. Hence, when a copyrighted songs or movies are played on the screen and by speaker of the computing device 110, the screen-recorded video files include such copyrighted audiovisual content, thereby potentially infringing such copyright. Thus, by setting the screen security item 230 to be ON, such potential copyright infringement can be avoided.

In at least one embodiment, when a user uploads a document, image, audio file, video file, or any file to a chatting room, the messaging application may provide an option for the uploading user to apply file-specific permissions to the uploaded file. For example, the uploading user may be able to indicate that a particular file should not be downloadable by other participants. The uploading user may also indicate that the uploaded file should expire after a particular time period and no longer be accessible to user. Also, the uploading user may be able to set a quality of the file for each participant. For example, an audio/video/image file may be played/downloaded with its full resolution for one group of users and with its downgraded resolution for another group of users.

Further, the uploading user may be able to set an access right when uploading a file. For example, for one group of users, the full access may be granted, and for another group of users, only a partial access may be granted. With an audio/video file, the one group of users may be able to play the whole, while a partial portion (e.g., the first few seconds or minutes) may be granted to the another group of users. With a document file, the one group of users can access the whole, while the another group may access a partial portion (e.g., the first few pages or every few other pages).

The user-specific permission settings are not limited the list described above but can include any other settings to enable the uploading user to fully control usages of the file that the uploading users uploads or shares in the chatting room. Also, the uploading user may be able to categorize the participating users into more than two groups and set settings specific for a respective group. In this way, the uploading user may be able to ensure privacy of and provide security to the content, which the uploading user uploads or shares, regardless of the settings set by the organizer of the chatting room.

Additionally or alternatively, the messaging server may allow the uploading user to cause a digital or visual watermark specific to be applied to the uploaded file. In at least one embodiment, the digital or visual watermark is uniquely applied based upon each individual user within the chat. For example, the digital or visual watermark may be a hash of, or otherwise integrated, each user's username, each user's public encryption key, or some other identifiable attribute of each user within the chat. Accordingly, in at least one embodiment, each user may receive a unique version of the uploaded file that the messaging application has created to include a watermark that is specific to the receiving user. This may allow the digital or visual watermark to operate such that if the uploaded file is copied, shared, or forwarded to others it is possible to find out who has done it by tracking back a trail of the watermark. Additionally or alternatively, the messaging application or the messaging server may add a watermark when the content is copied, forwarded, shared, screen-captured, or screen-recorded.

When the user tries to change the setting of the screen security item 230 from OFF to On, a popup window 270 may appear to ask the user whether the user wants to prevent screenshots and screen recordings of the private chat as illustrated in FIG. 2B. The user may confirm the change in the setting by clicking the “Confirm” button.

Now, returning to the setting of the screen block item 240, it is used to block copying, forwarding, and sharing functions. For example, when a user at a chatting room tries to share textual or audiovisual content, which might be related to copyright or privacy, by pressing such content for a predetermined period (e.g., one, two, or more than two seconds), privacy invasion or copyright infringement can occur when actually copied, shared, or forwarded. Such may be prevented by setting the screen block item 240 to be ON.

The user application setting screen 200 shows that the value of the screen block item 240 is OFF as a radio button being positioned in the left side of a radio button switch 245. In an aspect, the default setting of the screen block item 240 may be ON. When the user tries to set the screen block item 240 to be ON, a popup window 280 may appear to ask the user whether the user wants to prevent copying, forwarding, and sharing of the message (e.g., textual, audio, or visual content) in the private chat as illustrated in FIG. 2C. The user confirms the setting by clicking the “Confirm” button.

When both of the screen security item 230 and the screen block item 240 are set to be ON, the user setting application setting screen 200 shows that the radio buttons are positioned in the right side of the radio button switches 235 and 245 as illustrated in FIG. 2D.

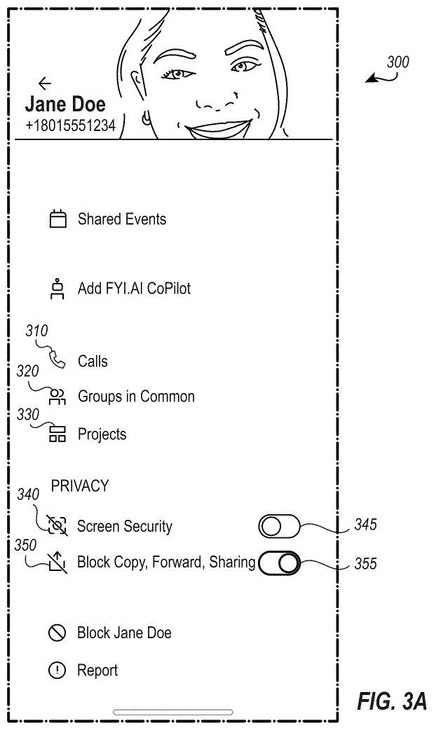

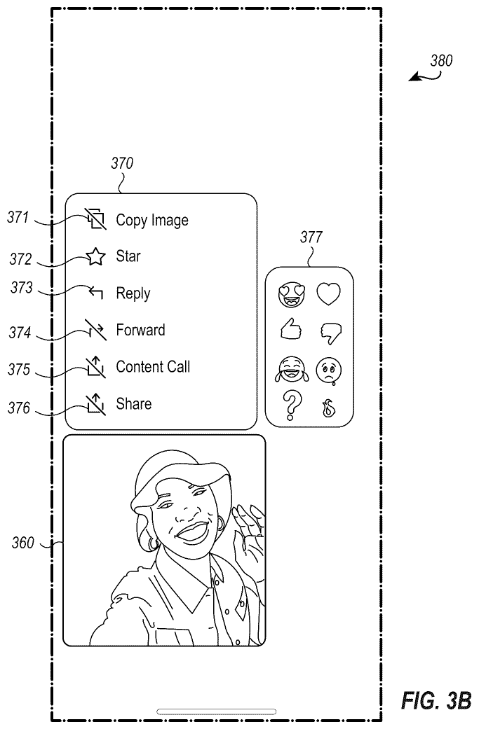

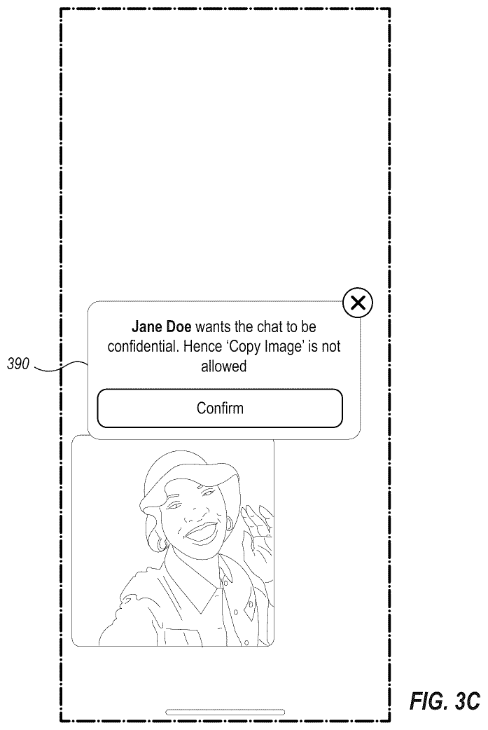

Now turning to FIGS. 3A-3C, illustrated are graphical illustrations of a chatting room setting screen 300 of the messaging application installed in the computing device 110 according to various aspects of the present disclosure. While the settings set by the user application setting screen 200 of FIG. 2A may be applied to all chatting rooms initiated by the user, the chatting room setting screen 300 of FIG. 3A may be applied only to the individual chatting room. In other words, the settings in the user application setting screen 200 may be default settings for all chatting rooms, and the settings in the chatting room setting screen 300 may be customized for the corresponding individual setting room.

The chatting room setting screen 300 may include chatting room feature items, a call item 310, a groups in common item 320, and a projects item 330.

The chatting room setting screen 300 may further include a screen security item 340 and a screen block item 350. Detailed description of the screen security item 340 and the screen block item 350 can be found in the description of the screen security item 230 and the screen block item 240 of FIG. 2A above.

As illustrated, the screen security item 340 is set to be OFF and the screen block item 350 is set to be ON. Thus, the screen-capture and screen-record features are allowed for this chatting room, while the copying, sharing, and forwarding features are prevented.

FIG. 3B illustrates a chatting room screen 380, in which the user tries to copy, share, forward, respond, or tag an emoticon to an image 360. When the image is selected and kept pressed for a predetermined period, a popup menu 370 is displayed over the chatting room screen 380 in a manner not obstructing the image 360. The popup menu 370 may include a copy item 371, a star item 372, a reply item 373, a forward item 374, a content call 375, and a share item 376. Since the screen block item 350 is ON in FIG. 3A, the copy item 371, the forward item 374, the content call 375, and the share item 376 are illustrated as being inactivated. Hence, the user is unable to copy, share, or forward the image 360.

On the other hand, the star item 372 and the reply item 373 are activated. The use is able to leave a star or any emoticon 377 to express the user's emotion to the image 360. Further, the user may be able to reply to the image 360 by selecting the reply item 373. The reply may be displayed in the chatting room screen 380 with a reduced image of the image 360 to indicate that the reply is to respond to the image 360. The image 360 is provided as an example and any text messages, documents shared, images, videos, audios, search results, or any content displayed on the chatting room screen 380 may be selected for copying, sharing, forwarding, screen-capturing, or screen-recording.

In a case where the user selects one of the inactivated menu items, such as the copy item 371, the messaging application may display a notification window 390, as illustrated in FIG. 3C, giving a notice to the user that the organizer or initiator of the chatting room wants the chat to be confidential and “Copy Image” is not allowed. The message displayed in the notification window 390 is provided as an example and may include other similar messages regarding privacy and security protection.

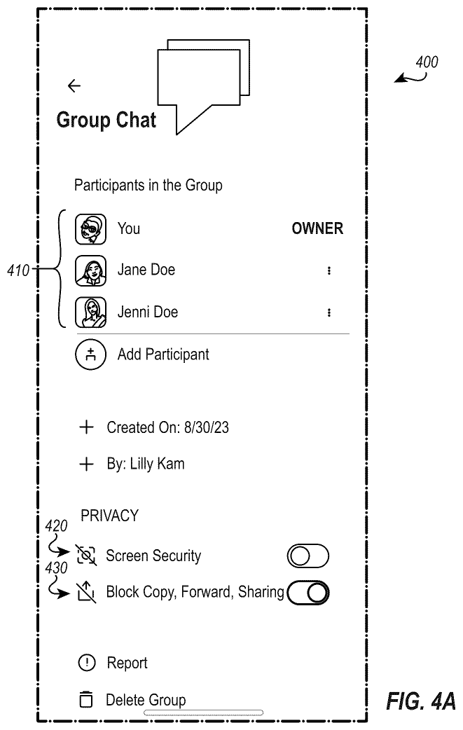

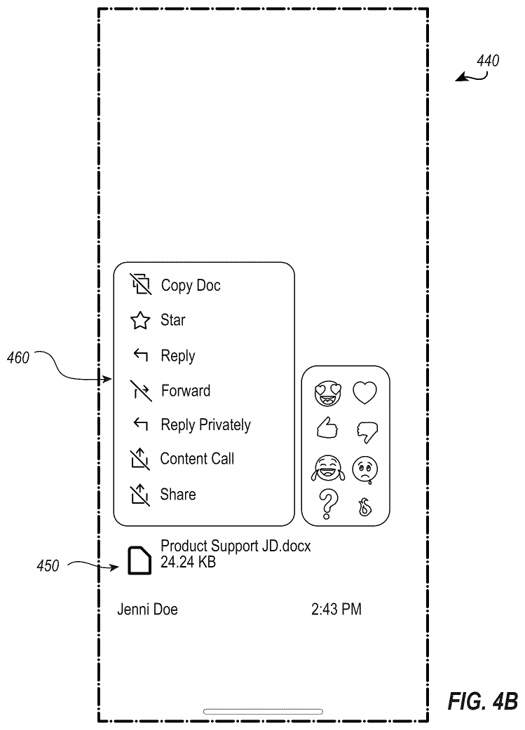

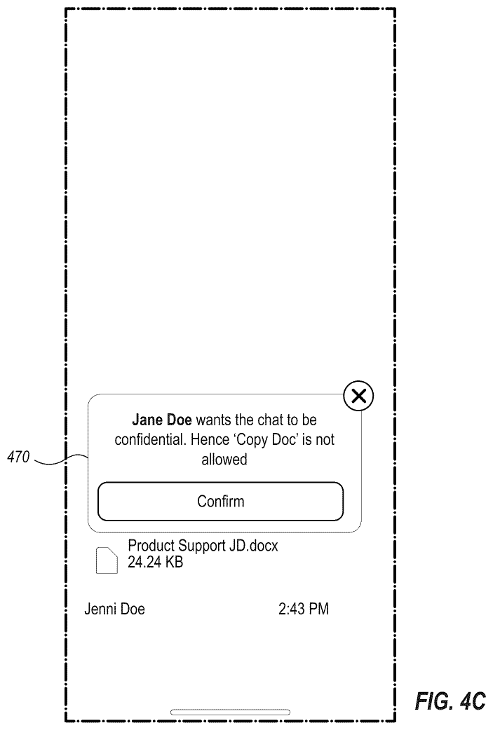

Now turning to FIG. 4A, illustrated is a graphical illustration of a chatting room setting screen 400 for a group chat in the messaging application installed in the computing device 110 according to various aspects of the present disclosure. The chatting room setting screen 400 may include a list 410 of users in the group chatting room. In the list, the organizer of the group chat may be able to add or invite another user by clicking “Add Participant.”

Further, the chatting room setting screen 400 may include a screen security item 420 and a screen block item 430, of which detailed description can be found in the screen security item 230 and the screen block item 240 of FIG. 2A above. When the organizer sets the setting of the screen security item 230 and/or the screen block item 240, the organizer may be able to set the setting for a partial group of users in the list 410. In this partial setting, the organizer may apply different permissions to one or more users within the group of users in the list 410. For instance, a first subgroup of users may be free to copy, share, forward, screen-capture, or screen-record the content, while the second subgroup of users are prohibited from copying, sharing, forwarding, screen-capturing, or screen-recording of the content, and vice versa.

Furthermore, when uploading or sharing a file, each uploading user may be able to set user-specific permissions by individually selecting a first subgroup of the users in the list 410 that are to receive a full version of an uploaded file and also a second subgroup of users in the list 410 that are to receive a degraded or otherwise altered version of the uploaded file. The message application may be configured to automatically apply the degradation or alteration to the uploaded file based upon the user-specific permissions. Each user within the subgroup chat may have the ability to set their own user-specific permissions such that every individual user has full control over the usage of files that they upload or share into the chat.

Now returning back to the chatting room setting screen 400, the organizer may differently set levels or rights of the users in the list 410. For example, when the purpose of the subgroup chatting room is to compose pop songs, the organizer may identify a first subgroup of users as audio engineers, a second subgroup as creators, a third subgroup as singers, and a fourth subgroup as peer-reviewers. The organizer may set user-specific permissions for each subgroup within the chat. For example, the organizer may set permissions that cause the messaging application to degrade the bit rate of the song based on which subgroup a given participant falls within. If a creator composes a digital song within a high fidelity format (e.g., a “lossless” version) and uploads it to the subgroup chatting room, each member of the chat subgroup will receive a particular version of that digital song based upon which permissions subgroup they fall within. For instance, a user in the peer-reviewer subgroup may receive an mp3 version of the song that is degraded to 128 kbps. In contrast, a user in the sound engineer subgroup may receive the original unaltered lossless version of the digital song. This ability to cause the messaging application to automatically degrade a digital song based upon the recipient provides the uploading user within significant control over their own content. For instance, the uploading user can ensure that his or her sound engineers are able to get the full lossless version of the song for professional processing, while at the same time providing a degraded version to peer-reviewers who can listen to the song and provide feedback but lack a high enough fidelity version to pose a market threat if it were to be leaked. In the above example, the bit rate is provided only as an example of a particular type file degradation.

Additionally or alternatively, the user who uploads an audio/video file may set settings specific for each subgroup. In this situation, the settings set by the organizer may have lower priority than the user's settings for the file to be uploaded. In other words, when the organizer sets the security item 420 as ON and a user sets a copy/share/forward setting for a subgroup of users, the subgroup of users may be able to copy/share/forward the file even though such is prohibited by the organizer.

In one instance when uploading a word file, the uploading user may be able to set a full access for a first subgroup and a partial access for a second subgroup. For example, the first subgroup may be able to download and edit/change/revise the original word file, while the second subgroup may be able to download it in a read-only version (e.g., a finalized read-only pdf format). Further, the uploading user may be able to set a setting so that the second subgroup may be able to download a pdf file with a resolution lower than that of the original word file.

In another instance when uploading a video file, the uploading user may be able to set a full access to a first subgroup and a partial access to a second subgroup. For example, the first subgroup may be able to download it with its full resolution, while the second subgroup may be able to download it with a lower resolution. Further, based upon the user-specific settings, the second subgroup of users may be able to download or watch a partial portion, which is shorter than the original full video file.

In still another instance when a watermark can be displayed over a file when viewed, the uploading user may be able to set settings so that the first subgroup may view the file without the watermark, while the second subgroup may view the file with the watermark. Before the file is copied, shared, or forwarded, the message application may apply the watermark to the file so that, when viewed, other users may be notified that the user who shares the file is not the original owner of the file. In this regard, the watermark may include information about the owner, the chatting room, or the timestamp at creation of the file, and other information that can be used to identify the owner of the file or the source of the file.

Unless there are any user-specific settings for files uploaded by a user, the settings set by the organizer for the chatting room will be applied to any shared files within the chatting room.

As illustrated, the screen security item 420 is inactivated and the block item 430 is activated. With these settings, one user uploads a document 450 to the group chatting room screen 440. When another user clicks and presses the document 450 for a predetermined period, a popup menu 460 may appear over the group chatting room screen 440. The popup menu 460 may include a copy image item, a star item, a reply item, a forward item, a content call, and a share item, as the popup menu 370 of FIG. 3B. Further based on the security and block settings, the copy item, forward item, content call item, and share item are inactivated, and the star item and the reply item are activated. When a user tries to select or click one of the inactivated items to copy the document 450, a notification window 470 is popped up to inform the user that the organizer of the group chat wants the chat to be confidential and copying the document is not allowed.

On the other hand, since the screen security item 420 is not activated, all users in the group chatting room may be able to screen-capture an image of the content displayed on the screen of the computing device and screen-record content displayed on the screen and any movie or audio played by the computing device. Thus, private messages or copyrighted videos or audios may be included in the screenshot or screen-recorded video, thereby potentially presenting privacy invasion or copyright infringement issues when such is shared with other users.

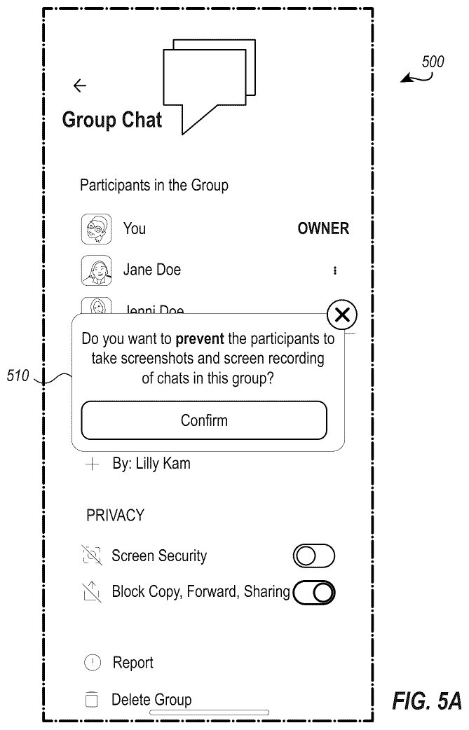

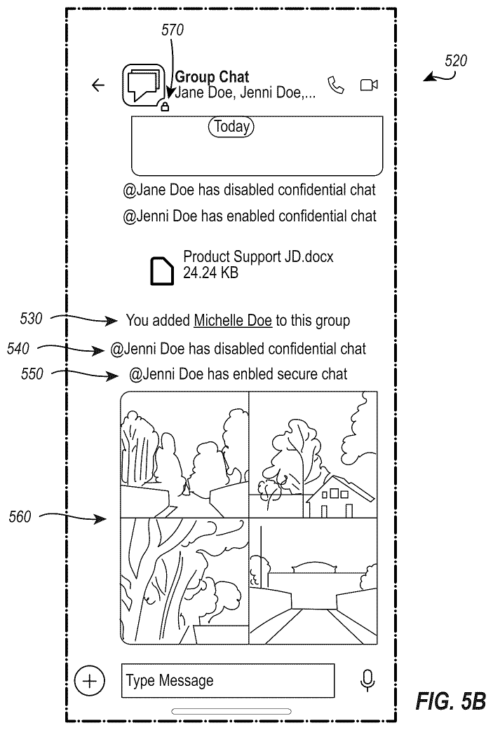

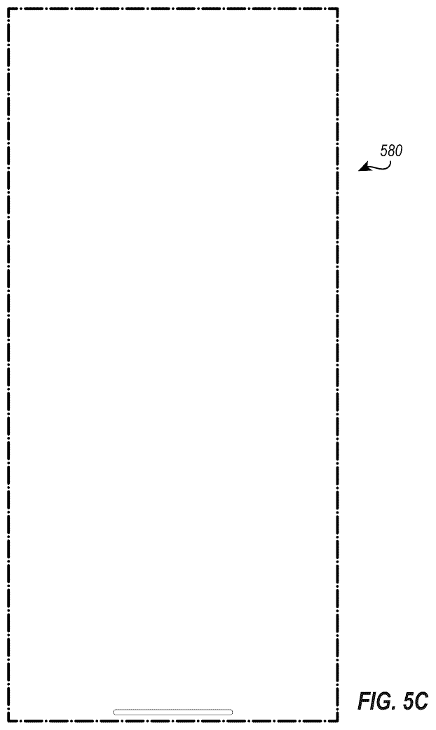

Turning now to the security item setting for a group chat, FIG. 5A illustrates a graphical illustration of a confirmation window 510 when an originator of the group chat enables the security item (e.g., the screen security item 420 of FIG. 4A) in a chatting room setting screen 500. The confirmation window 510 asks the organizer to confirm that the organizer wants to prevent the participants from taking screenshots and screen recording of content shared in the group chat. When a confirmation button is selected, the security item is set to be ON or activated.

In a group chatting room screen 520 of FIG. 5B, changes in users in the group chat is notified and the changes of the setting items are displayed to notify the changes to the user of the group chat. Such notification may be shown to the user only or to all the users in the group chatting room. Other notifications may be displayed to inform all the users of changes. In particular, a notification 530 notifies the users that another user is added to the group chat. Another notification 540 notifies that the organizer has disabled confidential chat or the block item. Still another notification 550 notifies that the organizer has enabled secure chat or the security item has been set to be ON from OFF.

After this change in the security setting, no user is able to screen-capture or screen-record the content shared in the group chat. Also, a lock icon 570 may be displayed at the top of the group chatting room to notify all users that the group chat is secured. As illustrated, images 560 are shared in the group chat after the change. Thus, when a user in the group chat attempts to screen-capture the content shared in the group chat, instead of the appearance of the group chatting room as illustrated in FIG. 5B, a default image 580, as illustrated in FIG. 5C, may be saved in the predetermined folder, which has been designated by the operating system to save screen-captured images. The default image 580 may be a blank image. Likewise, when a user attempts to screen-record the content shared in the group chat, a default video may be saved in the predetermined folder, which has been designated by the operating system to save screen-record videos. The default video may be a blank video. In an aspect, the predetermined folder for saving screenshots may be different from the predetermined folder for saving screen-record files.

In aspects, the messaging application may be able to intercept such attempts for screen-capturing or screen-recording. For example, there is a system flag or variable (e.g., FLAG_SECURE in android systems) for a screen-capture. When the messaging application is able to make changes to the system variable for screen-capture or screen-record, the messaging application may be able to disable the functions of screen-capture and screen-record.

On the other hand, it is possible that the messaging application may be unable to change the system variable for the screen-capture or screen-record. In this case, users in the one-to-one or group chat may be able to screen-capture an image of content displayed on the screen and screen-record content shared in the chatting room regardless of settings of the security item and the block item. The present disclosure provides a way to address privacy and security concerns in this situation.

When the security item is set to be ON in the messaging application and when the system saves a screenshot or image of the content in the predetermined folder, the messaging application may access the predetermined folder, remove the screenshot, and replace the screenshot with a default image, such as the default image 580 of FIG. 5C.

Likewise, when the security item is set to be ON in the messaging application and when the system saves a screen-recorded video file in the predetermined folder, the messaging application may access the predetermined folder, remove the screen-recorded video file, and replace the screen-recorded video file with a default video, which is a blank or empty video file. The way how the messaging application removes or replaces the screenshots or screen-recorded video files is not limited hereto but may comprise other ways readily appreciated by a person having ordinary skill in the art.

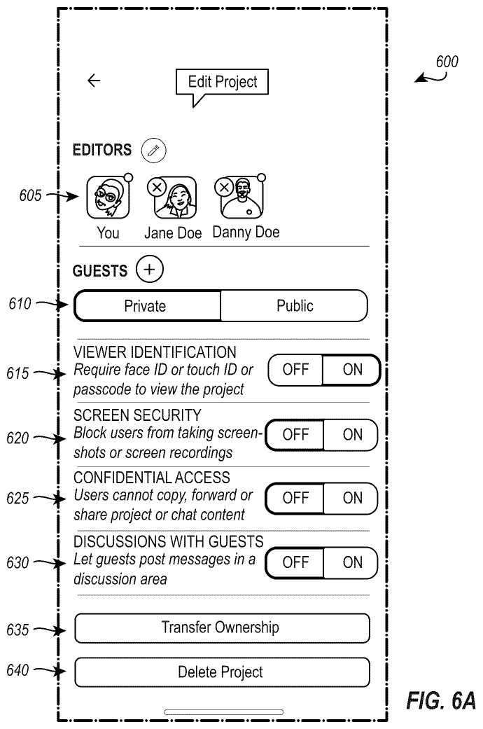

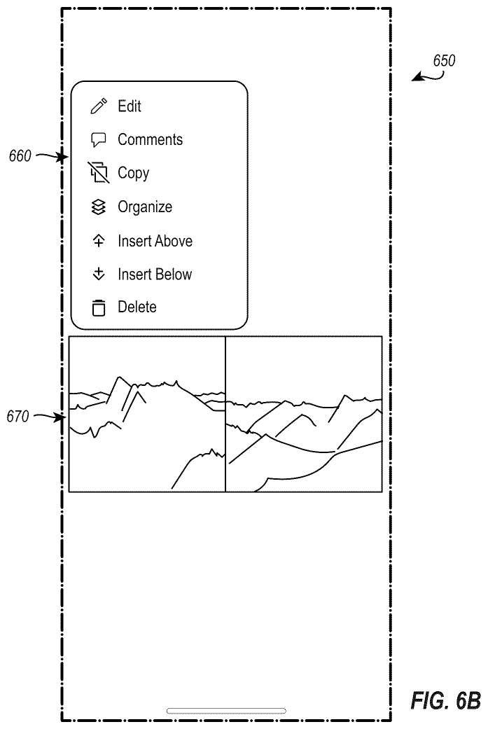

Now turning to FIG. 6A, illustrated is a graphical illustration of a project setting screen 600 for a project according to various aspects of the present disclosure. Unlike the group chat, the project owner may be able to differentiate users in the project. According to the project setting screen 600, the project owner may designate editors 605 who can change the settings of the project and/or have similar power to that of the project owner. The project owner may invite other users as guests 610 who may not be able to change the settings of the project but may be able to participate in a chat in a project chatting room based on a setting.

The projecting setting screen 600 may include menu items, which are a private item 610, a viewer identification item 615, a screen security item 620, a screen block item 625, and a guest discussion item 630. Based on the setting of the private item 610, the project owner may be able to make the project chatting room private or public. When the project chatting room is set to be public, anyone can see the project chatting room so that the project can receive attention from the public. When the project chatting room is set to be private, no one other than the invited editors 605 and guests 610 can see the project chatting room.

The viewer identification item 615, when set to be ON, requires a user to enter the ID and password to log in to the project chatting room so that the security and privacy of the project can be protected with another level of security. The ID may be a face ID, login ID, pattern, or passcode. The list of IDs is not limited thereto but may include other types of ID (e.g., driver's license, government-issued identification, patterns in an eye, vein patterns in a hand, etc.) as currently recognized in the security area. In an aspect, the ID may be the ID for the computing device or a separate ID for the messaging application.

The details of the screen security item 620 and the screen block item 625 can be found in those of the screen security item 230 and the screen block item 240 of FIG. 2A above. In an aspect, when the project owner sets the setting of the screen security item 620 and/or the screen block item 625, the user may be able to set the setting for a partial group of users, such as invited guest 610. In this partial setting, the project owner may confide with the other users (e.g., the editors 605) and does not worry about their copying, sharing, forwarding, screen-capturing, or screen-recording of the content, while the invited guests 610 may be prohibited from copying, sharing, forwarding, screen-capturing, or screen-recording of the content. In another aspect, the project owner may be able to set the screen security item and the screen block item for a partial group of the guests 610 so that the guests in the partial group may be able to enjoy similar privilege as the editors 605.

When the guest discussion item 630 is set to be ON, guest users 610 may be able to participate in the project chat. On the other hand, when the guest discussion item 630 is set to be OFF, the guest users may not be able to participate in the project chat but may be able to see the project chat to find out how the project advances.

The project setting screen 600 may further include a transfer item 635 and a deletion item 640. The project owner may be able to transfer the ownership of the project to another user by selecting the transfer item 635.

The deletion item 640 may be used to delete the project. When selected, the editors 605 and the guests 610 may be notified that the project is deleted and are exited when the project is deleted.

As illustrated, the screen block item 625 is set to be ON in the project setting screen 600. When images 670 are shared in the project chatting room screen 650 of FIG. 6B and a user selects and presses the images 670 for a predetermined period, a popup menu 660 appears over the project chatting room screen 650. Due to the setting of the screen block item 625, the copy item is inactivated. Since the project has a higher security level than a one-to-one or group chat, sharing and forwarding options for the content shared in the project chatting room may be removed by default in the messaging application and thus, there is no menu item for the sharing or forwarding option included in the popup menu 660.

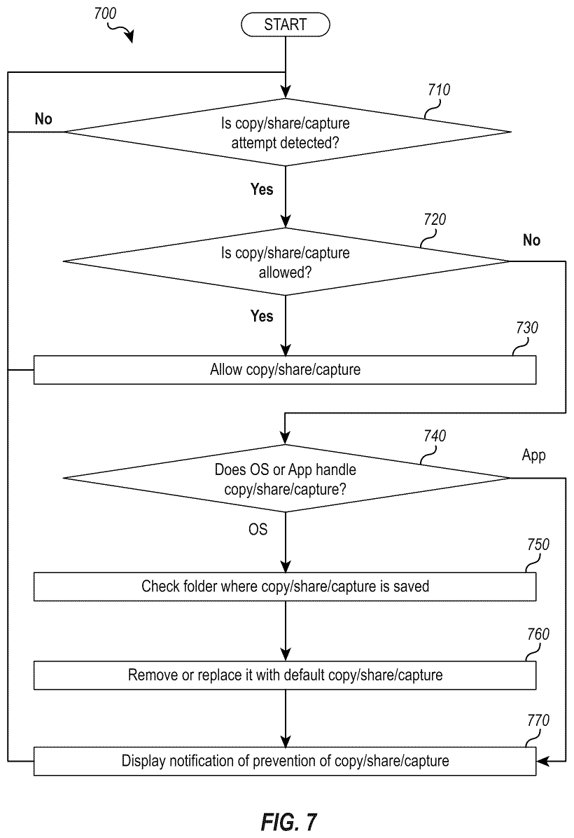

Turning now to FIG. 7, illustrated is a flow chart of a method 700 for protecting privacy and security within a messaging platform according to various aspects of the present disclosure. Messaging platforms or applications present various privacy and security issues based on possibilities that users in chatting rooms may be able to copy, forward, share contents shared in the chatting rooms and screen-capture or screen-record the content displayed on the chatting room or audiovisual content played by computing devices. The content shared in the chatting rooms may include private, offensive, confidential, or copyrighted images, videos, audios, or text messages.

Specifically, phone or video calls between users in a chatting room may be recorded by the screen-recording function. A call history may include names of the other party, which might expose privacy issues, and may be captured by the screen-capture function or even the copy/forward/share function. Chatting room screen may include search results, and users may share confidential documents, images, blueprints, videos, and audios. With regard to projects, content appearing in the project chat and the project itself may be confidential, and archived content in the project's file screen and folders within may be confidential and private. This list of confidential, private, copyrighted, secure content is not extensive but can include any other content, which poses privacy or security issues, when captured, copied, forwarded, shared, or recorded. The method 700 may protect such content from being captured, copied, forwarded, shared, or recorded based on appropriate settings.

The method 700 may include act 710, which is performed by determining whether or not a copy/share/forward/capture/record attempt is detected in a messaging platform. The copy/share/forward attempt may be detected based on the direct contact on content by a user within the messaging platform. For example, when the user selects the content by clicking the content with the right button of the user's mouse and chooses a menu item for the copy/share/forward menu item. Or, when the user uses a smart device, places a finger on the content, and keeps pressing the content with the finger for a predetermined period, the menu items pop up and the user chooses the copy/share/forward menu item.

With regard to the capture/record attempt, the messaging platform may detect that attempt when a user uses a hotkey or system level command to initiate the screen-capture or screen-record function.

When no attempt is detected, the method 700 keeps performing the act 710. It is noted that the act 710 is performed in the background, meaning that other operations and functions are performed in the foreground in the messaging platform.

When the attempt is detected in the act 710, the method may further include act 720, which is performed by determining whether or not the copy/share/forward/capture/record is allowed based on the settings of the messaging platform. For example, when the setting of the screen security item (e.g., the screen security item 230 of FIG. 2A) is OFF, the screen-capture and the screen-record functions are allowed, and when the setting of the screen block item (e.g., the screen block item 240 of FIG. 2A) is OFF, the copy/share/forward functions are allowed.

In an aspect, within the desktop of the messaging platform or the messaging application, settings of the messaging application can be set, and within a chatting room or a project chatting room, settings of the chatting room or the project chatting room can be set. When settings within the chatting room conflict with the settings in the messaging application, the settings of the chatting room may have a higher priority than those of the messaging application.

When it is determined that the copy/share/forward/capture/record function is allowed in the act 720, the copy/share/forward/capture/record attempt is allowed. Specifically, the capture function may include the screen-capture function and the screen-record function. Selected content may be copied, shared, or forwarded as the user has intended, the content displayed on the chatting room may be captured and saved in a predetermined folder, which has been designated by the operating system, or the content displayed on the chatting room and any audio/visual played by the computing device may be recorded and stored in a predetermined folder. In an aspect, the predetermined folder for screen-captured images may be different from the predetermined folder for screen-recorded videos.

When it is determined that the copy/share/forward/capture function is not allowed in the act 720, the method 700 may include further acts to disallow the capture/record attempt. In act 740, it is determined whether or not the operating system of the messaging platform or the messaging application handles the capture/record function.

In a case where it is determined that the messaging application handles the capture/record function, the method 700 may include act 770, which is performed by displaying a notification of prevention of the screen-capture or screen-record function on the screen over the chatting room so that failure or prevention of the function is notified to the user attempting to perform the screen-capture or screen-record function. Then, the method 700 may go back to the act 710 and repeat the acts 710-770 until the chatting room is ended.

On the other hand, in a case where it is determined that the operating system handles the capture/record function, the operating system performs the capture function. In other words, it is the operating system that captures an image of the content displayed on the chatting room screen, records a video file based on the content displayed on the chatting room screen and audio/video played by the computing device, and saves captured images and recorded videos at a respective predetermined folder.

To prevent such stored images and recorded videos from being disseminated to other users, the method 700 may further include act 750, which is performed by checking the predetermined folder. Particularly, in a case where the screen-capture attempt is detected in the act 710, the predetermined folder for saving screen-captured images is checked in the act 750, or in a case where the screen-record attempt is detected in the act 710, the predetermined folder for saving screen-recorded videos is checked.

In an aspect, the act 750 further checks whether the screen-captured image or screen-recorded video is saved at the predetermined folder based on the timestamp of the image or video. When there is a saved file, based on its timestamp, at the predetermined folder at the time when the screen-capture or screen-record was attempted, the method 700 may further include act 760, which is performed by removing or replacing the saved file with a default file. Specifically, the messaging application may find and remove the saved file, which corresponds to the screen-captured image or screen-recorded video, from the predetermined folder.

In an aspect, the saved file, which corresponds to the screen-captured image or screen-recorded video, may be replaced with a default file, which may be a blank image or video. In this way, even though the operating system may capture an image or record a video of the content displayed on the chatting room at the system-level, the messaging application may be able to remove or replace the saved file with a blank file so that private, confidential, or copyrighted content shared and/or played in the chatting room is prevented from potential sharing, copying, forwarding to others, thereby increasing the privacy and the security within the messaging platform.

The method 700 may further include act 770, which is performed by displaying a notification of prevention of the screen-capture or screen-record function on the screen of the computing device over the chatting room so that the user attempting to do the function is notified. Then, the method 700 may go back to the act 710 and repeat the acts 710-770 until the chatting room is ended.

Computing system functionality can be enhanced by a computing system for ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a plurality of web based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

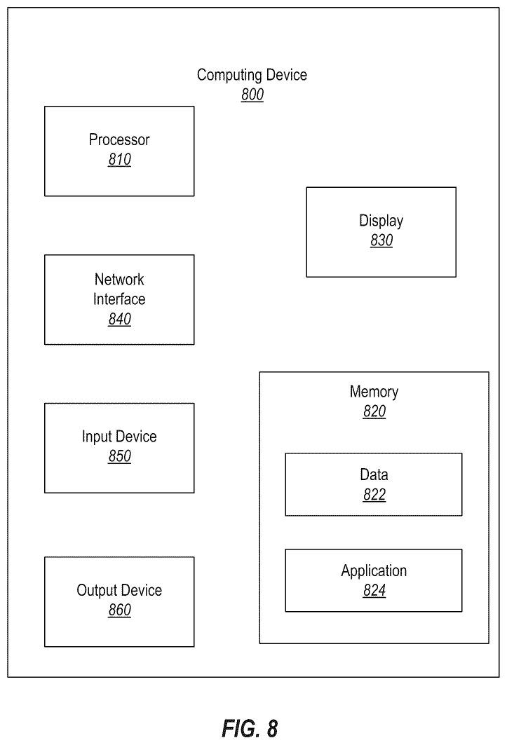

Turning now to FIG. 8, disclosed aspects may comprise or utilize a special purpose or general-purpose computing device 800 including computer hardware, as discussed in greater detail below. The computing device 800 may be a laptop or desktop computer, server, edge computer, or cloud computer. The computing device 800 may include a processor 810, a memory 820, a display 830, a network interface 840, an input device 850, and/or an output device 860. The memory 820 includes any non-transitory computer-readable storage media for storing data and/or software that is executable by the processor 810 and which controls the operation of the computing device 800.

The computing device 800 may include an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Unix®, Apple® Mac OS X Server®, Oracle® Solaris®, Windows Server®, Windows®, Novell®, NetWare®, iOS®, Android®, or any other operating system readily available. In some aspects, the operating system is provided by cloud computing.

The processor 810 may be a general purpose processor, a specialized graphics processing unit (GPU) configured to perform specific graphics processing tasks (e.g., parallel processing for training and testing data packets for potential cyberattacks) while freeing up the general-purpose processor to perform other tasks, and/or any number or combination of such processors, digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The memory 820 may include one or more solid-state storage devices such as flash memory chips. Alternatively or in addition to the one or more solid-state storage devices, the memory 820 may include one or more mass storage devices connected to the processor 810 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 810. That is, computer readable storage media may include non-transitory, volatile and non-volatile, removable and non-removable media implemented in any method or technology for storage of information such as computer-readable instructions, data structures, program modules or other data. For example, computer-readable storage media includes random access memory (RAM), read-only memory (ROM), erasable programmable read-only memory (EPROM), electrically erasable programmable read-only memory (EEPROM), flash memory or other solid state memory technology, compact disc read-only memory (CD-ROM), digital video disc (DVD), Blu-Ray or other optical storage, magnetic cassettes, magnetic tape, magnetic disk storage or other magnetic storage devices, or any other medium which can be used to store the desired information and which can be accessed by the computing device 800.

The memory 820 may store application 824 (e.g., fingerprint database, AI algorithm, etc.) and/or data 822 (e.g., fingerprints). The application 824 may, when executed by processor 810, cause the display 830 to present the user interface to provide information to users. The application 824 may be one or more software programs stored in the memory 820 and executed by the processor 810 of the computing device 800. The application 824 may be installed directly on the computing device 800 or via the network interface 840. The application 824 may run natively on the computing device 800, as a web-based application, or any other format known to those skilled in the art.

In an aspect, the application 824 may include a sequence of process-executable instructions, which can perform any of the herein described methods, programs, algorithms or codes, which are converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C, Delphi, Fortran, Java, JavaScript, python, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The display 830 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 830 is a plasma display, and a video projector. In various aspects, the display 830 may be interactive (e.g., having a touch screen or a sensor such as a camera, a 3D sensor, etc.) that can detect user interactions/gestures/responses and the like so as to serve as both an input and output device.

The network interface 840 may be configured to connect to a network such as a local area network (LAN) consisting of a wired network and/or a wireless network, a wide area network (WAN), a wireless mobile network, a Bluetooth network, and/or the internet.

For example, the computing device 800 may process digital measurement data obtained from the multi-arm spiral antenna, through the network interface 840, to identify a direction of the transmission source of the signal. The computing device 800 may update the AI algorithm, for example, the application 824, via the network interface 840. The computing device 800 may also display processed results and any notification from training and/or testing on the display 830.

The input device 850 may be any device by means of which a user may interact with the computing device 800, such as, for example, a mouse, keyboard, touch screen, and/or any other interface. The output device 860 may include any connectivity port or bus, such as, for example, parallel ports, serial ports, universal serial busses (USB), or any other similar connectivity port known to those skilled in the art.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing apparatus for protecting privacy and security within a messaging platform, comprising:
one or more processors; and
one or more computer-readable media having stored thereon executable instructions that, when executed by the one or more processors, cause the computing apparatus to:
receive a user's attempt to access content shared within the messaging platform;
determine whether or not privacy is set for protection within the messaging platform;
in a case where it is determined that the privacy is set for protection:
disallow an access to the content; and
display a notification of protection of the content to a user; and
in a case where it is determined that the privacy is not set for protection, allow the user to access the content.

2. The computing apparatus according to claim 1, wherein the content is a text, audio, video, document, image, audio call, or video call.

3. The computing apparatus according to claim 1, wherein privacy of the content is individually set by a user who uploads.

4. The computing apparatus according to claim 2, wherein the privacy of the content set by the user has a higher priority than the privacy set within the messaging platform.

5. The computing apparatus according to claim 1, wherein the user's attempt is a hotkey handled by an operating system of the messaging platform.

6. The computing apparatus according to claim 5, wherein the executable instructions, when executed by the one or more processors, further cause the computing apparatus to, in the case where it is determined that the privacy is set for protection:
access a predetermined folder where a copy of the content is to be stored; and
remove or replace the copy of the content with a default file.

7. The computing apparatus according to claim 6, wherein the default file is a blank text, audio, video, document, or image.

8. The computing apparatus according to claim 1, wherein determination of whether or not the privacy is set for protection is based on a privacy protection setting within the messaging platform.

9. The computing apparatus according to claim 8, wherein the privacy protection setting is set for a partial group of users in a group chat within the messaging platform.

10. The computing apparatus according to claim 8, wherein the privacy protection setting includes a setting for blocking a capture of a screen and a setting for blocking a copy, forward, or share of the content.

11. A method for protecting privacy within a messaging platform, comprising:
receiving a user's attempt to access content shared within the messaging platform;
determining whether or not privacy is set for protection within the messaging platform;
in a case where it is determined that the privacy is set for protection:
disallowing an access to the content; and
displaying a notification of protection of the content to a user; and
in a case where it is determined that the privacy is not set for protection, allowing the user to access the content.

12. The method according to claim 11, wherein the content is a text, audio, video, document, image, audio call, or video call.

13. The method according to claim 11, wherein privacy of the content is individually set by a user who uploads.

14. The method according to claim 12, wherein the privacy of the content set by the user has a higher priority than the privacy set within the messaging platform.

15. The method according to claim 11, wherein the user's attempt is a hotkey handled by an operating system of the messaging platform.

16. The method according to claim 15, further comprising, in the case where it is determined that the privacy is set for protection:
accessing a predetermined folder where a copy of the content is to be stored for the access; and
removing or replacing the copy of the content with a default file.

17. The method according to claim 16, wherein the default file is a blank text, audio, video, document, or image.

18. The method according to claim 11, wherein determination of whether or not the privacy is set for protection is based on a privacy protection setting within the messaging platform.

19. The method according to claim 18, wherein the privacy protection setting is set for a partial group of users in a group chat within the messaging platform.

20. A nontransitory computing readable content having stored thereon executable instructions that, when executed by a computing apparatus, cause the computing apparatus to perform a method for protecting privacy within a messaging platform, comprising:
receiving a user's attempt to access content shared within the messaging platform;
determining whether or not privacy is set for protection within the messaging platform;
in a case where it is determined that the privacy is set for protection:
disallowing an access to the content; and
displaying a notification of protection of the content to a user; and
in a case where it is determined that the privacy is not set for protection, allowing the user to access the content.
